(19) United States
(12) Patent Application Publication
(10) Pub. No.: US 2010/0102129 A1
(43) Pub. Date: Apr. 29, 2010

(54) BAR CODE READER WITH SPLIT FIELD OF VIEW

(75) Inventors: Mark Drzymala, Commack, NY (US); Edward D. Barkan, Miller Place, NY (US); Bradley S. Carlson, Huntington, NY (US); Paul Dvorkis, East Setauket, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 12/260,168

(22) Filed: Oct. 29, 2008

(51) Int. Cl. G06K 7/10

(52) U.S. Cl. 235/462.42

(57) ABSTRACT

A multicamera imaging-based bar code reader 10 for imaging a target bar code 30 on a target object 32 features: a housing 20 supporting a plurality of transparent windows H, V and defining an interior region, an imaging system including a plurality of camera assemblies C1-C3 coupled to an image processing system, each camera assembly of the plurality of camera assemblies being positioned within the housing interior. Each camera assembly includes a sensor array. Light reflecting fold mirrors split light from a given camera assembly into portions that are directed out of the housing to different fields of view. Light bounces from a target in a camera field of view back along said light path to the image capture sensor array.

### FIELD OF THE INVENTION

The present invention relates to an imaging-based bar code reader having a mirror arrangement that defines a field of view for such a bar code reader.

### BACKGROUND OF THE INVENTION

Various electro-optical systems have been developed for reading optical indicia, such as bar codes. A bar code is a coded pattern of graphical indicia comprised of a series of bars and spaces of varying widths, the bars and spaces having differing light reflecting characteristics. The pattern of the bars and spaces encode information. Bar code may be one dimensional (e.g., UPC bar code) or two dimensional (e.g., DataMatrix bar code). Systems that read, that is, image and decode bar codes employing imaging camera systems are typically referred to as imaging-based bar code readers or bar code scanners.

Imaging-based bar code readers may be portable or stationary. A portable bar code reader is one that is adapted to be held in a user's hand and moved with respect to a target indicia, such as a target bar code, to be read, that is, imaged and decoded. Stationary bar code readers are mounted in a fixed position, for example, relative to a point-of-sales counter. Target objects, e.g., a product package that includes a target bar code, are moved or swiped past one of the one or more transparent windows and thereby pass within a field of view of the stationary bar code readers. The bar code reader typically provides an audible and/or visual signal to indicate the target bar code has been successfully imaged and decoded.

A typical example where a stationary imaging-based bar code reader would be utilized includes a point of sale counter/cash register where customers pay for their purchases. The reader is typically enclosed in a housing that is installed in the counter and normally includes a vertically oriented transparent window and/or a horizontally oriented transparent window, either of which may be used for reading the target bar code affixed to the target object, i.e., the product or product packaging for the product having the target bar code imprinted or affixed to it. The sales person (or customer in the case of self-service check out) sequentially presents each target object's bar code either to the vertically oriented window or the horizontally oriented window, whichever is more convenient given the specific size and shape of the target object and the position of the bar code on the target object.

A stationary imaging-based bar code reader that has a plurality of imaging cameras can be referred to as a multi-camera imaging-based scanner or bar code reader. In a multi-camera imaging reader, each camera system typically is positioned behind one of the plurality of transparent windows such that it has a different field of view from every other camera system. While the fields of view may overlap to some degree, the effective or total field of view of the reader is increased by adding additional camera systems. Hence, the desirability of multi-camera readers as compared to single camera readers which have a smaller effective field of view and require presentation of a target bar code to the reader in a very limited orientation to obtain a successful, decodable image, that is, an image of the target bar code that is decodable.

The camera systems of a multi-camera imaging reader may be positioned within the housing and with respect to the transparent windows such that when a target object is presented to the housing for reading the target bar code on the target object, the target object is imaged by the plurality of imaging camera systems, each camera providing a different image of the target object. U.S. patent application Ser. No. 11/862,568 filed Sep. 27, 2007 entitled ‘Multiple Camera Imaging Based Bar Code Reader’ is assigned to the assignee of the present invention and is incorporated herein by reference. U.S. patent application Ser. No. 12/112,275 entitled “Bar Code Reader having multiple Cameras” filed Apr. 30, 2008 is assigned to the assignee of the present invention and is also incorporated herein by reference. U.S. Pat. No. 5,717,195 to Feng et al concerns an “Imaging Based Slot Datform Reader” having a mirror, camera assembly with photosensor array and a illumination system. The disclosure of that patent is incorporated herein by reference.

### SUMMARY OF THE INVENTION

A bar code reader is disclosed for decoding a target bar code on a target object. The illustrative bar code reader has a housing supporting one or more transparent windows and defining an interior region. A target object is presented in relation to the housing for imaging a target bar code.

An imaging system inside the housing has a camera that uses an image capture sensor array for capturing an image of a bar code within a camera field of view. A light source is positioned in close proximity to the image capture sensor of the camera. At least two light reflecting fold mirrors are positioned with respect to said light source and the sensor array to reflect light from the light source to two different camera fields of view. The fold mirrors also transmit light that bounces from a target in a field of view back to the image capture sensor array. An image processing system has a processor such as a microprocessor controller for identifying a bar code from images captured by the imaging system. In one exemplary embodiment, the processor evaluates picture elements for a presence of a bar code from different portions of the image capture sensor array in a time multiplexed fashion, examining first one and then a second camera field of view.

These and other objects, advantages, and features of the exemplary embodiment of the invention are described in detail in conjunction with the accompanying drawings.

### BRIEF DESCRIPTION OF THE DRAWINGS

FIG. 1 is a perspective view of a bar code reader having a vertical and a horizontal window through which bar codes are viewed by multiple cameras within the reader;

FIG. 2 is a perspective view of the reader of FIG. 1 with a portion of the reader housing removed to illustrate three cameras mounted to a printed circuit board and also showing the positioning of multiple reflecting mirrors;

FIG. 3 and 4 are perspective views showing light paths for different cameras resulting in one camera providing two different camera fields of view; and

FIG. 5 is a schematic block diagram of selected systems and electrical circuitry of the bar code reader of FIG. 1.

### DETAILED DESCRIPTION

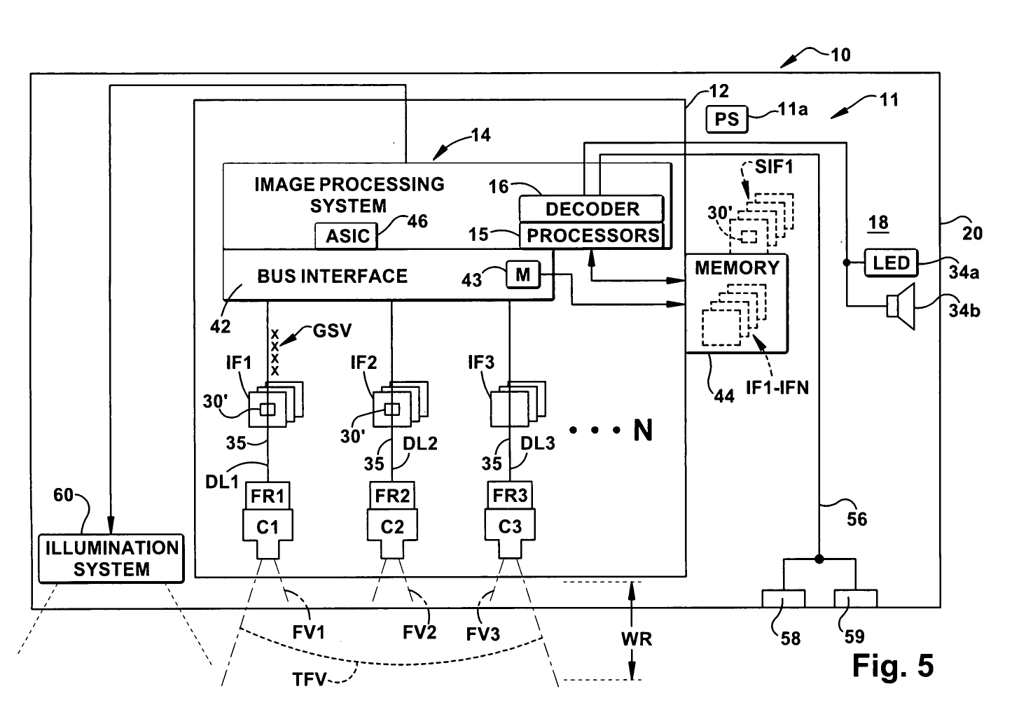

An exemplary embodiment of an imaging-based bar code reader 10 of the present invention is shown in the Figures. As depicted in the schematic block diagram of FIG. 5, the bar code reader 10 includes circuitry 11 comprising an imaging system 12 which includes a plurality of imaging cameras and in the exemplary embodiment there are three cameras which produce raw gray scale images.

An image processing system 14 includes one or more processors 15 and a decoder 16 that analyzes the gray scale images from the cameras and decodes imaged target bar codes, if present. The imaging system 12 is capable of imaging and decoding both ID and 2D bar codes and postal codes. The reader 10 is also capable of capturing images and signatures. The decoder 16 may be integrated into the reader 10 or may be a separate system, as would be understood by one of skill in the art. Three cameras are used in the exemplary embodiment but more or fewer cameras may be used in the reader 10 depending on the reader design and use. As a result, the FIG. 5 depiction contemplates a possibility of having N cameras where N is an integer that can be less than, equal to, or greater than 3.

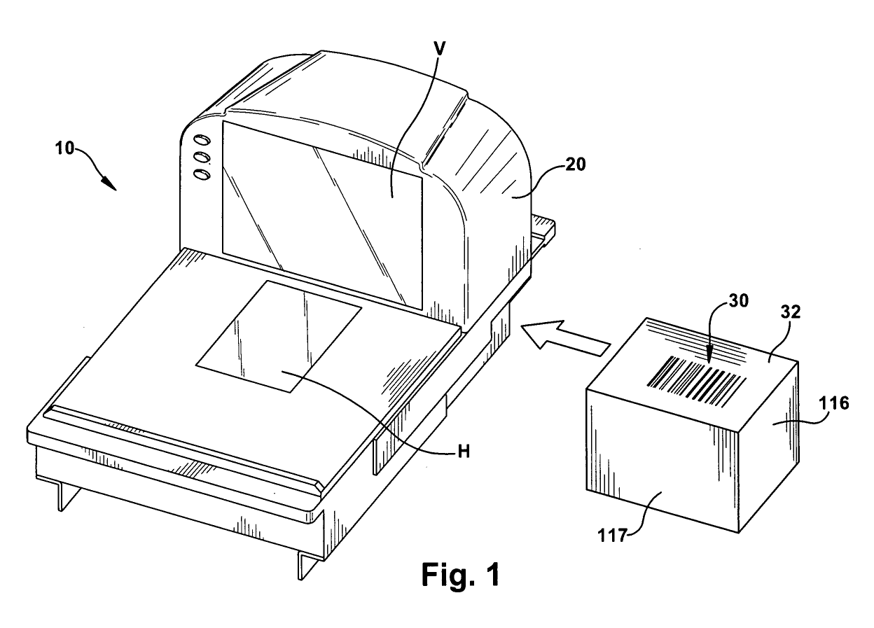

In one exemplary embodiment, the reader's decoder is supported within an interior region of a housing 20 (see FIG. 1). The housing 20 may be integrated into a sales counter of a point of sales system that includes, for example, a cash register, a touch screen visual display or other type user interface and a printer for generating sales receipts. The housing 20 depicted in FIG. 1 includes two transparent windows H,V. The reader 10 of FIG. 1 is stationary, the disclosed concepts have applicability to a handheld bar code reader. A six sided object 32 is shown moving into a reader field of view. One goal of the invention is a simplification in the reader due to the fact that at least one camera has a split field of view that images different sides of the object 32 and more particularly will read and decode a bar code 30 within its split field of view.

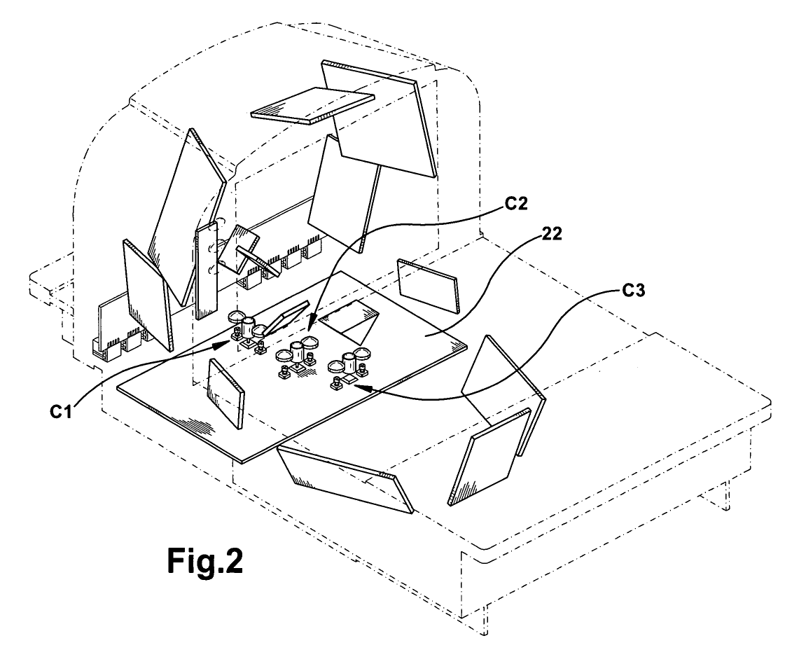

In the exemplary embodiment, the multiple camera assemblies C1-C3 are mounted to a printed circuit board 22 (FIG. 2) inside the housing and each camera defines a field of view FV1, FV2, FV3. Positioned behind and adjacent to the windows H,V are reflective mirrors that help define a given camera field of view such that the respective fields of view pass from the housing 20 through the windows creating an effective total field of view TFV for the reader 10 in a region of the windows H, V, outside the housing 20. Because each camera C1-C3 has an effective working range WR (shown schematically in FIG. 5) over which a target bar code 30 may be successfully imaged and decoded, there is an effective target area in front of the windows H,V within which a target bar code 30 may be successfully imaged and decoded.

In accordance with one use, either a sales person or a customer will swipe (or present) a product or target object 32 selected for purchase to the housing 20. More particularly, a target bar code 30 imprinted or affixed to the target object will be swiped through a region near the windows H,V for reading, that is, imaging and decoding of the coded indicia of the target bar code. Upon a successful reading of the target bar code, a visual and/or audible signal will be generated by the reader 10 to indicate to the user that the target bar code 30 has been successfully imaged and decoded. The successful read indication may be in the form of illumination of a light emitting diode (LED) 34a (FIG. 5) and/or generation of an audible sound by a speaker 34b upon appropriate signal from the decoder 16.

Each of the three camera assemblies C1-C3 used with the exemplary imaging system 12 captures a series of image frames of its respective field of view FV1-FV3. The series of image frames for each camera assembly C1-C3 is shown schematically as IF1-IFN in FIG. 5. Each series of image frames IF1-IFN comprises a sequence of individual image frames generated by the camera assemblies C1-C3. The image frames are in the form of digital signals representative of raw gray scale values.

Use of a global shutter and a mega-pixel sensor array (having 1280 by 960 picture elements or pixels) in the cameras allows three imaging cameras C1-C3 to cover the required scan volume from the two windows H, V. This is achieved by splitting the camera field of view of a mega-pixel sensor into two parts of approximately equal size. Each half of the camera field of view is caused to exit one of the two windows in orientations similar to what would have otherwise been done with two individual wide VGA cameras. Since each half field of view of the mega-pixel sensor has more resolution then a single WVGA sensor (750 by 480 pixels), the exemplary embodiment provides higher resolution, and therefore better working range on high density barcodes, than a design that exclusively uses WVGA sensors. In addition, the aspect ratio of each half field of view is close to what is needed to fill the windows H, V of a bar code reader

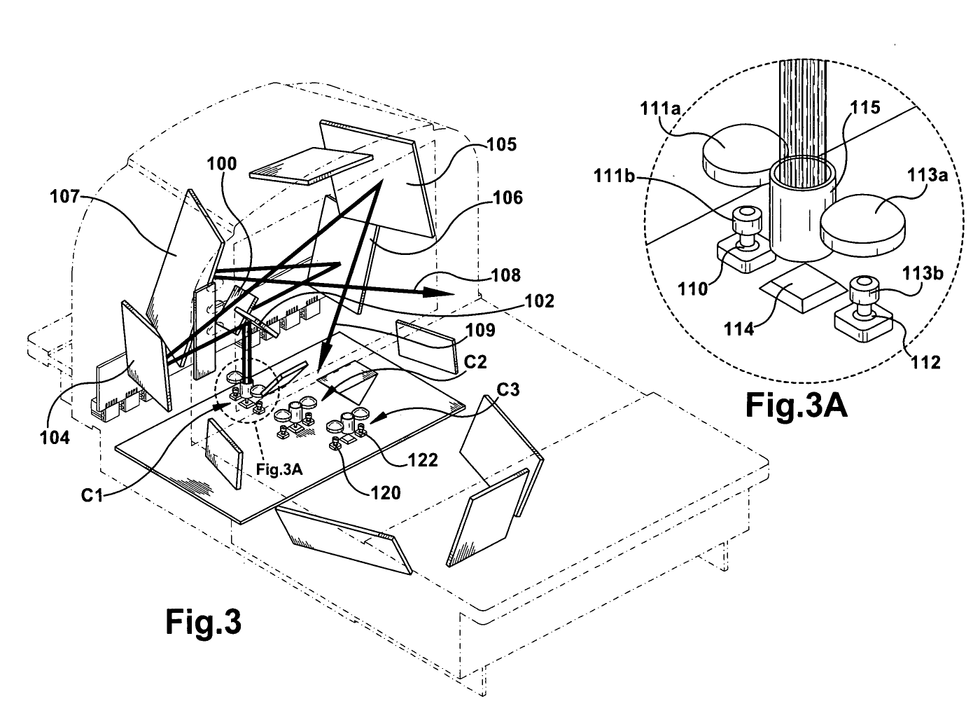

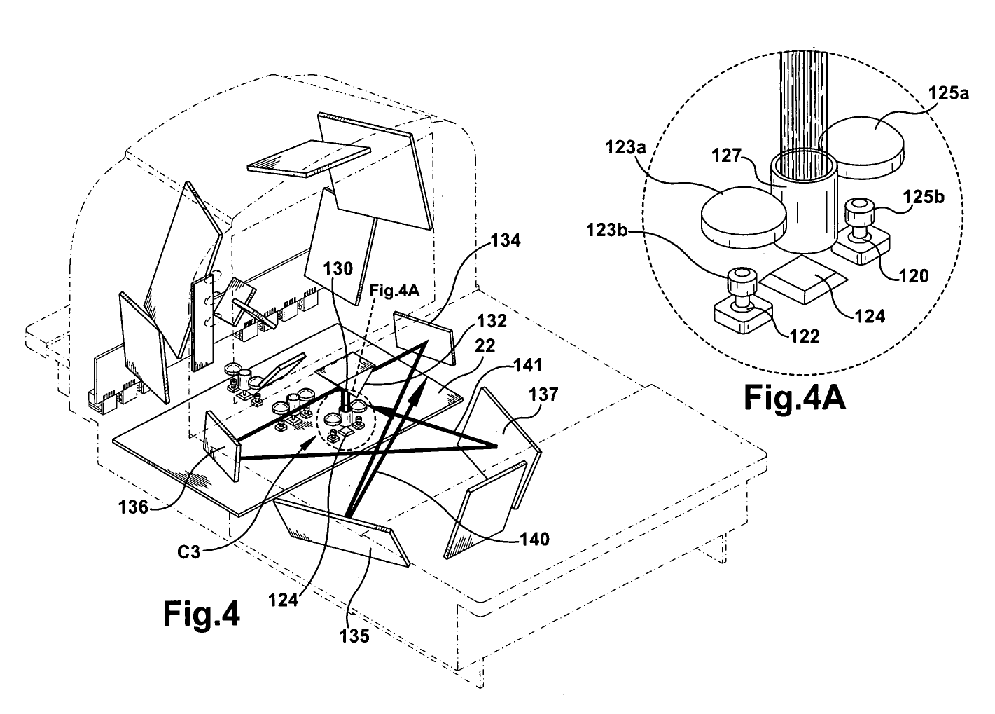

FIGS. 3 and 4 illustrate illustrate splitting the fields of view from two cameras C1, C3 having mega-pixel sensor arrays that can be split by appropriate positioning of field defining fold mirrors. In FIG. 3 two mirrors 100, 102 split the field of view of the camera C1 into halves so that other fold mirrors 104-107 can direct the light from the camera assemblies that bounces off from these mirrors to paths 108, 109 that exit the window V in widely different orientations. This design reduces the number of cameras needed to adequately image bar codes from six (if WVGA cameras were used) to three for the bar code reader 10. It would also be possible to split the field of view into more than 2 parts, should that prove to be advantageous in some applications.

In the exemplary embodiment a first portion (typically one half) of a camera sensor array is exposed and then a subsequent portion exposed. On a first exposure, a processor coupled to the camera evaluates at one half of its field of view, followed by an evaluation of the other half on the next exposure. Two LEDs 110, 112 for the camera C1 are activated by a controller 15 within the image processing system 14. The sequence and timing of the light emitting diodes is controlled by this processor or controller. The two mirrors 100, 102 that redirect light from these light emitting diodes have generally planar reflecting surfaces but light deflection could also employ slightly concave or convex surfaces.

Turning to FIG. 3A, one sees the camera assembly C1 has two spaced apart light emitting diodes 110, 112 that are closely adjacent to a sensor array 114. When a first light emitting diode 110 is energized, after bouncing off from the fold mirrors 100, 106, 107 light centered by a light ray 108 is emitted from the housing 20 in a direction for imaging a back and leading edge surfaces of the object as movement of that object is depicted in FIG. 1. In the exemplary embodiment closely spaced means from 1 to 1.5 cm spacing between the center of the light emitting diode and the center of the array. When a second light emitting diode 112 is energized, after bouncing off from the fold mirrors 102, 104, 105 light centered by a light ray 109 is emitted from the housing and directed in a direction to scan a trailing edge surface 116 of the object as movement of that object is depicted in FIG. 1.

As depicted in FIG. 3A, the light emitted from the light emitting diode 110, 112 passes through a combination of a light pipe and two focusing lenses before reaching the two mirrors 100, 102. The lenses 111a, 111b shape the relatively diffuse output from the light emitting diode 110 to a more focused light beam. The lenses 113a, 113b shape the relatively diffuse output from the light emitting diode 112 to a more focused light beam.

Turning to FIG. 4A, one sees the camera assembly C3 having two spaced apart light emitting diodes 120, 122 that are closely adjacent to a sensor array 124. The diodes direct light through associated combination light pipe and lens systems. When a first light emitting diode 120 is energized light passes through a light pipe and two lenses 125a, 125b bounces off from a prism having a mirrored surface 132 and then from the fold mirrors 134, 135 so that light centered by a light ray 140 is emitted from the housing and directed in a direction to scan the front surface 117 leading surface and bottom surface of the package 32 as movement of that object is depicted in FIG. 1. Return light from the package passes through a lens 127 and impacts the sensor array 124. When a second light emitting diode 122 is energized (typically at a later time interval) light passes through a light pipe and two lenses 123a, 123b bounces off from the mirrored surface 130 and then from the fold mirrors 136, 137 so that light centered by a light ray 141 is emitted from the housing and directed in a direction to scan the front trailing and bottom surfaces of the package 32 as movement of that object is depicted in FIG. 1 Return light from the package passes through the lens 127 and impacts the same sensor array 124 but the processor 15 evaluates a different portion of the sensor array to evaluate a split field of view. In the exemplary embodiment closely spaced means from 1 to 1.5 cm spacing between the center of each light emitting diode and the center of the sensor array 124.

Features and functions of the fold mirrors shown in the figures are described in further detail in U.S. patent application Ser. No. 12/245,111 to Drzymala et al filed Oct. 3, 2008 which is incorporated herein by reference. When a mirror is used in an optical layout to reflect the reader field of view to another direction, the mirror may be thought of as an aperture (an aperture is a defined as a hole or an opening through which light is admitted). The depictions in the copending application show optical layouts which represent one or more fold mirrors that achieve long path lengths within the reader housing. When the mirror clips or defines the imaging or camera field of view it is referred to as vignetting. When the mirror clips extraneous or unneeded light from a source such as a light emitting diode, it is commonly referred to as baffling. In FIGS. 3 and 4 three fold mirrors are used to define a given field of view. Other numbers of mirrors, however, could be used to direct light to a field of view outside the housing.

These sensor arrays of the exemplary three cameras C1-C3 can operate at 45 frames per second when exposing full frames, so half frames can be operate at around twice that speed, resulting in each half of the sensor being exposed around 45 times each second. The WVGA sensor, on the other hand, can operate at 60 frames per second. The three mega-pixel cameras C1-C3, each with a split field of view, produce 270 half-frames per second. A comparable reader using six WVGA cameras would produce a total of 360 frames per second. Forty five frames per second is enough to achieve 100 inches per second of swipe speed. The lower rate might degrade first pass read rate on poor quality barcodes that might require more then one exposure to decode.

An alternate mode of operation uses less then half of the field of view for each of the six scanning directions by windowing a smaller portion of the sensor. This would allow increased frame rate, but would reduce the sizes of the fields of view, which means that the scan windows won't be entirely filled. This should be adequate when swiping barcodes, but will be less good when presenting barcodes, since there will be portions of the scan window that are not covered by the field of view of any of the cameras. This can be helped by adding anamorphic focusing optics to stretch the narrowed fields of view to fill up the gaps in the scan field.

Each camera includes a charged coupled device (CCD), a complementary metal oxide semiconductor (CMOS), or other imaging pixel array, operating under the control of the imaging processors 15. Signals 35 are raw, digitized gray scale values which correspond to a series of generated image frames for each camera. The digital signals 35 are coupled to a bus interface 42, where the signals are multiplexed by a multiplexer 43 and then communicated to a memory 44 in an organized fashion so that the processor knows which image representation belong to a given camera.

The image processors 15 access the image frames IF1-IFN from memory 44 and search for image frames that include an imaged target bar code 30′. If the imaged target bar code 30′ is present and decodable in one or more image frames, the decoder 16 attempts to decode the imaged target bar code 30′ using one or more of the image frames having the imaged target bar code 30′ or a portion thereof. For any individual presentation of a target bar code 30 to the reader windows H, V the orientation and manner of presentation of the target bar code 30 to the windows determines which camera or cameras generate suitable images for decoding.

The reader circuitry 11 includes imaging system 12, the memory 44 and a power supply 11a. The power supply 11a is electrically coupled to and provides power to the circuitry 11 of the reader. The reader includes an illumination system 60 (shown schematically in FIG. 5) which provides illumination (described in greater detail below) to illuminate the effective total field of view TFV that facilitates obtaining an image of a target bar code 30.

For each camera assembly C1-C3, the sensor array is enabled during an exposure period to capture an image of the field of view FV1-FV4 of the camera assembly. The total field of view TFV is a function of both the configuration of the sensor array and the optical characteristics of the imaging lens assembly and the distance and orientation between the array and the lens assembly.

For each camera assembly C1-C3, electrical signals are generated by reading out some or all of the pixels of the pixel array after an exposure period generating the gray scale value digital signal 35. This occurs as follows: within each camera, the light receiving photosensor/pixels of the sensor array are charged during an exposure period. Upon reading out of the pixels of the sensor array, an analog voltage signal is generated whose magnitude corresponds to the charge of each pixel read out. The image signals 35 of each camera assembly C1-C3 represents a sequence of photosensor voltage values, the magnitude of each value representing an intensity of the reflected light received by a photosensor/pixel during an exposure period.

Processing circuitry of the camera assembly, including gain and digitizing circuitry, then digitizes and converts the analog signal into a digital signal whose magnitude corresponds to raw gray scale values of the pixels. The series of gray scale values GSV represent successive image frames generated by the camera assembly. The digitized signal 35 comprises a sequence of digital gray scale values typically ranging from 0-255 (for an eight bit A/D converter, i.e., 2⁸=256), where a 0 gray scale value would represent an absence of any reflected light received by a pixel during an exposure or integration period (characterized as low pixel brightness) and a 255 gray scale value would represent a very intense level of reflected light received by a pixel during an exposure period (characterized as high pixel brightness). In some sensors, particularly CMOS sensors, all pixels of the pixel array are not exposed at the same time, thus, reading out of some pixels may coincide in time with an exposure period for some other pixels.

As is best seen in FIG. 5, the digital signals 35 are received by the bus interface 42 of the image processing system 40, which may include the multiplexer 43, operating under the control of an ASIC, to serialize the image data contained in the digital signals 35. The digitized gray scale values of the digitized signal 35 are stored in the memory 44. The digital values GSV constitute a digitized gray scale version of the series of image frames IF1-IFN, which for each camera assembly C1-C3 and for each image frame is representative of the image projected by the imaging lens assembly onto the pixel array during an exposure period. If the field of view of the imaging lens assembly includes the target bar code 30, then a digital gray scale value image 30′ of the target bar code 30 would be present in the digitized image frame.

The decoding circuitry 14 then operates on selected image frames and attempts to decode any decodable image within the image frames, e.g., the imaged target bar code 30′. If the decoding is successful, decoded data 56, representative of the data/information coded in the target bar code 30 is then output via a data output port 58 and/or displayed to a user of the reader 10 via a display 59. Upon achieving a good read of the target bar code 30, that is, the bar code 30 was successfully imaged and decoded, the speaker 34b and/or an indicator LED 34a is activated by the bar code reader circuitry 11 to indicate to the user that the target bar code 30 has successfully read.

While the present invention has been described with a degree of particularity, it is the intent that the invention includes all modifications and alterations from the disclosed design falling within the spirit or scope of the appended claims.

What is claimed:

1. A bar code reader for decoding a target bar code on a target object, the bar code reader comprising:
a housing including one or more transparent windows and defining a housing interior region, a target object being swiped or presented in relation to the transparent windows for imaging a target bar code;
an imaging system comprising
a camera having an image capture sensor array positioned within the housing interior region for capturing an image of a bar code within a camera field of view;
a light source for the camera positioned in close proximity to the image capture sensor of said camera; and
a field splitting light reflecting fold mirror positioned with respect to said light source and the sensor array for reflecting light from the light source to produce two or more camera fields of view and transmitting light that bounces from a target in a field of view back to the image capture sensor array; and
an image processing system comprising a processor for identifying a bar code from images captured by the imaging system.

2. The bar code reader of claim 1 wherein the imaging system has multiple cameras and light sources wherein each camera includes at least one light source positioned in close proximity to an associated image capture sensor array.

3. The bar code reader of claim 1 wherein the light source comprises a light emitting diode that is turned on and off at successive controlled intervals by the processor to capture images from the two or more fields of view.

4. The bar code reader of claim 3 comprising one light emitting diode for each of the two or more camera fields of view.

5. The bar code reader of claim 1 wherein the sensor array gathers light that reflects off two or more light reflecting fold mirrors on a return path from an object within a field of view.

6. The bar code reader of claim 1 wherein the image capture sensor array intercepts light from one field of view and the processor interprets signals from one portion of the sensor array to image said one field of view and wherein light from a different field of view is also intercepted by the sensor and the processor interprets signals from a different portion of the sensor array to image said different field of view.

7. The bar code reader of claim 6 wherein one light emitting diode is activated to provide light to the one field of view and a different light emitting diode is activated to provide light to illuminate a field of view.

8. The bar code reader of claim 1 wherein the processor evaluates less than an entire area of the image capture array to determine a presence of a bar code in each field of view.

9. The bar code reader of claim 1 wherein two field splitting light reflecting fold mirrors are positioned with respect to the source to reflect light in different directions to two different fields of view.

10. The bar code reader of claim 9 wherein two light emitting diodes are activated in timed sequence, one diode being activated for one field of view and a second diode being activated for a second field of view.

11. The bar code reader of claim 1 wherein the field splitting fold mirror comprises a prism having two light reflecting mirror surfaces.

12. A method for imaging a target bar code comprising:
providing a housing having one or more transparent windows that define a region for movement and/or positioning of an object having a bar code;
positioning a camera having a sensor array within the housing for imaging bar codes on objects outside the housing;
activating a light source positioned within said housing next to the sensor array of said camera and deflecting light emitted from the light source off from at least one field splitting fold mirror positioned between the source and the one or more transparent windows to illuminate two different camera fields of view;
capturing an image from both camera fields of view as light from said fields of view impinges onto said sensor array; and
interpreting images from the two camera fields of view to determine a presence of a bar code.

13. The method of claim 12 wherein the light source comprises first and second light emitting diodes emitting diodes that are activated in a timed sequence to illuminate different fields of view.

14. The method of claim 12 wherein the image sensor comprises an array of picture elements and wherein a first portion of the picture elements that make up the array images one field of view and a second portion of the picture elements that make up the array images a second field of view.

15. The method of claim 12 wherein light from the light source bounces off from a prism having two light reflecting mirrored surfaces.

16. An imaging system for use in a multi-camera imaging-based bar code reader having a housing supporting a plurality of transparent windows and defining an interior region, a target object being presented near or moved with respect to the plurality of windows for imaging a target bar code on a target object, the imaging system comprising:
a plurality of camera assemblies coupled to an image processing system, each camera assembly of the plurality of camera assemblies being positioned within the housing interior position and defining a field of view which is different than a field of view of each other camera assembly of the plurality of camera assemblies, each camera assembly including a sensor array and a light source in close proximity to the sensor array;
a plurality of mirrors associated with each of the plurality of camera assemblies for splitting light from a light source to travel to two or more camera fields and for returning light bouncing off a target object back to the sensor array of said camera assembly; and
one or more processors for evaluating images captured by said plurality of camera assemblies.

17. The system of claim 16 wherein illumination light from one or more of the camera assemblies bounces off multiple fold mirrors prior to exiting the housing through one of the transparent windows.

18. An imaging-based bar code reader for imaging a target bar code on a target object, the bar code reader comprising:
a housing supporting one or more transparent windows and defining an interior region, a target object being presented to or swiped through the housing for imaging a target bar code;
an imaging system comprising
camera means having an image capture sensor array positioned within the housing interior region for capturing an image of a bar code within a camera field of view;
light source means for the camera positioned in close proximity to the image capture sensor of said camera for emitting light; and
field splitting means for defining multiple camera fields of view including mirrors positioned with respect to said light source and the sensor array along a light path to transmit light from light source to the field of view and transmit light that bounces from a target in the field of view back along said light path to the image capture sensor array; and
image processing means for selectively activating the light source means and identifying a bar code from images captured by the imaging system.
